(19) United States
(12) Patent Application Publication
(10) Pub. No.: US 2026/0217559 A1
(43) Pub. Date: Jul. 30, 2026

(54) PRECURSOR OF POSITIVE ELECTRODE ACTIVE MATERIAL

(71) Applicant: TOYOTA JIDOSHA KABUSHIKI KAISHA, Toyota-shi (JP)

(72) Inventors: Kenji YOKOE, Toyota-shi (JP); Momoko Procter, Seto-shi (JP)

(73) Assignee: TOYOTA JIDOSHA KABUSHIKI KAISHA, Toyota-shi (JP)

(21) Appl. No.: 19/413,033

(22) Filed: Dec. 9, 2025

(30) Foreign Application Priority Data
Jan. 24, 2025 (JP) 2025-010255

(51) Int. Cl. C01G 53/05

(52) U.S. Cl. CPC C01G 53/05; C01P 2004/03; C01P 2004/61; C01P 2004/90; C01P 2006/40

(57) ABSTRACT

The present disclosure relates to a precursor of a positive electrode active material. The precursor is a nickel composite hydroxide, and the precursor contains more than 0% by mass of precursor particles having a true roundness of more than 0.10, the true roundness being calculated from a scanning electron microscope (SEM) image.

### CROSS-REFERENCE TO RELATED APPLICATION

This application claims priority to Japanese Patent Application No. 2025-010255 filed on Jan. 24, 2025. The disclosure of the above-identified application, including the specification, drawings, and claims, is incorporated by reference herein in its entirety.

### BACKGROUND

### 1. Technical Field

The present disclosure relates to a precursor of a positive electrode active material.

### 2. Description of Related Art

Various techniques have been proposed for a positive electrode active material as disclosed in Japanese Unexamined Patent Application Publication No. 2022-146720 (JP 2022-146720 A) and Japanese Unexamined Patent Application Publication No. 2021-24764 (JP 2021-24764 A).

### SUMMARY

Various positive electrode active materials have been proposed in order to obtain a positive electrode having high battery characteristics such as high cycle characteristics and high output characteristics.

For example, JP 2022-146720 A discloses a positive electrode active material for an all-solid-state lithium ion battery. The positive electrode active material is represented by a compositional formula: LiₐNiₓCo_{y}Mn_{1-x-y}O₂ (in the formula, 1.00≤a≤1.03, 0.8≤x≤0.9, and 0≤y≤0.16), has a 50% cumulative volume particle size D50 of 3.0 μm to 7.0 μm, has a tapped density of 1.9 g/cc to 2.5 g/cc, and has a circularity of 0.90 to 0.93.

In JP 2022-146720 A, the circularity is an index indicating how close the shape of the particle is to a sphere, and for example, the circularity of a spherical particle is 1.00, which is the upper limit thereof. In addition, the following expression is described as an expression for calculating the circularity.

$$Circularity = 4 π S / {L}^{2}$$

(in the expression, S is a projected area of the particle, L is a perimeter of the particle projected image, and π is a circular constant)

The positive electrode using the positive electrode active material as described in JP 2022-146720 A has a problem of low output characteristics. The reason is that a positive electrode layer and a positive electrode collector constituting the positive electrode are easily peeled off.

The present disclosure has been made in view of the circumstances, and provides a precursor of a positive electrode active material capable of improving a peel strength between a positive electrode layer and a positive electrode collector.

1

That is, the present disclosure includes the following aspects.

A precursor of a positive electrode active material, in which
the precursor is a nickel composite hydroxide, and
the precursor contains more than 0% by mass of precursor particles having a true roundness of more than 0.10, the true roundness being calculated from a scanning electron microscope (SEM) image.
   2

The precursor according to 1, in which
the true roundness is 0.20 or more, and a particle diameter on a long side of the precursor particles is 2.1 μm or more and 10.2 μm or less.
   3

The precursor according to 1 or 2, in which
the true roundness is 0.20 or more, and the precursor contains 10% by mass or more of the precursor particles.

The precursor according to any one of 1 to 3, in which
the true roundness is 3.60 or less.
   5

The precursor according to any one of 1 to 4, in which
the nickel composite hydroxide is a nickel cobalt manganese composite hydroxide.

According to the present disclosure, it is possible to provide a precursor of a positive electrode active material capable of improving a peel strength between a positive electrode layer and a positive electrode collector.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an SEM image of precursor particles having a high circularity included in a precursor of the present disclosure; and

FIG. 2 is an SEM image of precursor particles having a low circularity included in the precursor of the present disclosure.

### DETAILED DESCRIPTION OF EMBODIMENTS

Embodiments according to the present disclosure will be described below. It is noted that matters necessary for implementing the present disclosure other than the matters particularly mentioned in the present specification (for example, a general configuration and a production process of a positive electrode active material and a precursor thereof that do not characterize the present disclosure) can be understood as design matters of those skilled in the art based on the related art in the field. The present disclosure can be carried out based on the contents disclosed in the present specification and the common general technical knowledge in the field.

The present disclosure provides a precursor of a positive electrode active material, in which the precursor is a nickel composite hydroxide, and the precursor contains more than 0% by mass of precursor particles having a true roundness of more than 0.10, the true roundness being calculated from a scanning electron microscope (SEM) image.

In the present disclosure, the true roundness of the precursor particles is calculated as follows.

First, in a scanning electron microscope (SEM) image, lengths D of four diagonals formed by dividing the precursor particles into eight parts are measured. Among these, the true roundness is calculated from the following expression using the longest length (particle diameter Dmax on the long side) and the shortest length (particle diameter Dmin on the short side).

$$True roundness = ( D max - D min ) / 2$$

In addition, in the present disclosure, the true roundness of the precursor particles means an average value calculated from the true roundness of a plurality of precursor particles. That is, the precursor containing more than 0% by mass of the precursor particles having a true roundness of more than 0.10 means that the precursor contains more than 0% by mass of the precursor particles having an average value of the true roundness calculated from precursor particles of more than 0.10.

The number of precursor particles for which the true roundness is calculated may be two or more, but may be, for example, 60 or more or 100 or more. For 100 precursor particles for which the true roundness is calculated, an average value may be calculated for 60 precursor particles remaining after removing 20 precursor particles in descending order of the true roundness and 20 precursor particles in ascending order of the true roundness.

As the true roundness is closer to 0, the precursor particles have a higher circularity, that is, a shape close to a perfect circle. On the other hand, as the true roundness is larger, the precursor particles have a lower circularity, that is, a shape distorted from a perfect circle.

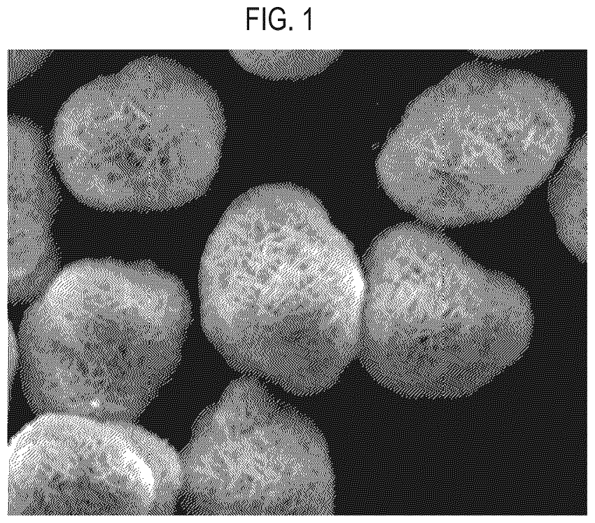

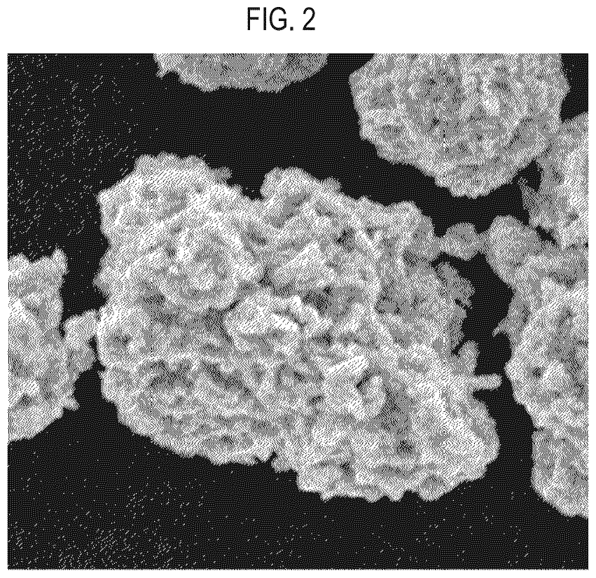

FIG. 1 is an SEM image of precursor particles having a high circularity included in the precursor of the present disclosure, and FIG. 2 is an SEM image of precursor particles having a low circularity included in the precursor of the present disclosure. As shown in FIG. 1, the precursor particles having a low true roundness of 0.10 or less included in the precursor of the present disclosure have a high circularity, and as shown in FIG. 2, the precursor particles having a high true roundness of more than 0.10 have a low circularity.

In a case of synthesizing the positive electrode active material by mixing the precursor particles having a true roundness of more than 0.10 with a metal compound serving as a metal source such as a lithium compound and then firing the mixture, the precursor particles can maintain the distorted shape to some extent, and the positive electrode active material having the distorted shape is formed. It is noted that the precursor particles having a true roundness of more than 0.10 may be referred to as high true roundness precursor particles hereinafter. The positive electrode layer containing the positive electrode active material having a distorted shape easily exhibits an anchoring effect, and the adhesiveness to the adjacent positive electrode collector (metal foil or the like) is higher than that of the positive electrode layer not containing the positive electrode active material having a distorted shape. Therefore, by using the precursor of the present disclosure, the peel strength between the positive electrode layer and the positive electrode collector can be improved. In order to increase the peel strength between the positive electrode layer and the positive electrode collector, the amount of the binder in the positive electrode layer may be increased, but the increase in the amount of the binder reduces the electron conductivity of the positive electrode layer, which increases the IV resistance (short-term IV resistance) of the battery. According to the present disclosure, since the positive electrode layer having excellent peel strength with the collector can be obtained without increasing the amount of the binder, the output characteristics of the positive electrode can be improved.

In the present disclosure, the true roundness of the high true roundness precursor particles may be more than 0.10, and may be 0.15 or more, 0.20 or more, or 0.30 or more. In addition, the true roundness of the high true roundness precursor particles may be 3.60 or less or 0.40 or less.

In addition, in the present disclosure, the precursor particles are usually secondary particles in which a plurality of primary particles are aggregated, but may include a single primary particle without aggregation in addition to the secondary particles. The particle shape is not particularly limited, and examples thereof include a substantially spherical shape and a substantially elliptical shape.

The size of the precursor particles is not particularly limited. The size of the precursor particles can be obtained by measuring the sizes of cross sections of a plurality of particles in an SEM image or a transmission electron microscope (TEM) image and calculating an average value thereof.

In the high true roundness precursor particles, the particle diameter Dmax on the long side (longest diagonal length) may be 2.1 μm or more and may be 10.2 μm or less. In addition, in the high true roundness precursor particles, the particle diameter Dmin on the short side (shortest diagonal length) may be 1.3 μm or more and may be 9.4 μm or less. Here, Dmax and Dmin are average values.

In the precursor of the present disclosure, a proportion of the high true roundness precursor particles is not particularly limited as long as it is more than 0% by mass. The proportion of the high true roundness precursor particles may be 10% by mass or more, 20% by mass or more, 50% by mass or more, or 100% by mass.

The precursor of the present disclosure is a nickel composite hydroxide. The nickel composite hydroxide is a hydroxide containing nickel (Ni) and another metal species other than nickel. The other metal species other than nickel may be one or two or more. Examples of the other metal species other than nickel include manganese (Mn), cobalt (Co), and aluminum (Al). Specific examples of the nickel composite hydroxide include a nickel cobalt composite hydroxide containing nickel and cobalt, a nickel cobalt manganese composite hydroxide containing nickel, cobalt, and manganese, and a nickel cobalt aluminum composite hydroxide containing nickel, cobalt, and aluminum. The nickel composite hydroxide may be a nickel cobalt manganese composite hydroxide.

In the nickel composite hydroxides, a proportion (molar ratio) of nickel and each of the other metal species to the total amount of nickel and the other metal species is not particularly limited. The molar ratio in a case of the nickel cobalt composite hydroxide may be as follows. Ni/NiCo may be 0.5 or more and less than 1.0, and Co/NiCo may be more than 0 and 0.5 or less. The molar ratio in a case of the nickel cobalt manganese composite hydroxide may be as follows. Ni/NiCoMn may be 0.5 or more and less than 1.0, Co/NiCoMn may be more than 0 and 0.3 or less, and Mn/NiCoMn may be more than 0 and 0.3 or less. The molar ratio in a case of the nickel cobalt aluminum composite hydroxide may be as follows. Ni/NiCoAl may be 0.5 or more and less than 1.0, Co/NiCoAl may be more than 0 and 0.3 or less, and Al/NiCoAl may be more than 0 and 0.3 or less.

It is noted that, in the present disclosure, the nickel composite hydroxide may contain a metal species other than nickel, cobalt, aluminum, and manganese. The other metal species may be, for example, at least one selected from the group consisting of Zr, Mo, Mg, Ca, Na, Fe, Cr, Zn, Si, Sn, and Ag.

A method for producing the precursor of the positive electrode active material according to the present disclosure is not particularly limited, and examples thereof include the following method.

First, a water-soluble nickel source (nickel compound) which is a raw material of the nickel composite hydroxide, and a water-soluble other metal source (cobalt compound, manganese compound, aluminum compound, or the like) are dissolved in ion exchange water to prepare a metal raw material aqueous solution. In this case, in the metal raw material aqueous solution, a proportion (mol %) of nickel and each of the other metal species to the total amount of nickel and the other metal species is typically set to be equal to a proportion (mol %) of nickel and each of the other metal species constituting the nickel composite hydroxide. The water-soluble metal compound is not particularly limited, and examples thereof include sulfates. A concentration of the metal raw material aqueous solution is not particularly limited, and for example, a concentration at which a total concentration of the metal species (proportion of all raw materials to the metal raw material aqueous solution) is 1.5 mol % can be used.

Next, an NH₃ aqueous solution (ammonium ion supply source) is added to the reaction container in a constant amount, and the inside of the reaction container is replaced with nitrogen and set to a non-oxidizing atmosphere while stirring with a stirrer or the like.

Subsequently, a sodium hydroxide aqueous solution is added to the reaction container, and the metal raw material aqueous solution and the NH₃ aqueous solution are added dropwise to the reaction container while maintaining the pH at an alkaline level (for example, pH 12).

In this case, by setting the conditions such that the nucleus generation and the nucleus growth of the nickel composite hydroxide proceed at the same time, the precursor particles having a true roundness of more than 0.10 can be formed. It is considered that, under the conditions in which the nucleus generation and the nucleus growth proceed at the same time, first, primary particles having different sizes are formed, and when the primary particles form secondary particles, the value of the true roundness is large, that is, the secondary particles are distorted from a perfect circle. Examples of the conditions in which the nucleus generation and the nucleus growth proceed at the same time include reducing a stirring speed during the dropwise addition of the metal raw material aqueous solution and the NH₃ aqueous solution to be lower than normal. Specifically, for example, the stirring speed can be set to 100 rpm to 700 rpm.

In the same conditions in which the stirring speed is the same, for example, the reaction time can be changed to form precursor particles having different true roundness. For example, the reaction time can be shortened to increase the true roundness. The reaction time may be, for example, 1 hour to 20 hours. A reaction temperature is not particularly limited, and for example, can be set to 60° C.

After the reaction is completed, a drying treatment is performed. The drying treatment can be performed, for example, in an inert gas atmosphere at 120° C. for 1 hour.

The precursor of the positive electrode active material according to the present disclosure can be used as a positive electrode active material of a lithium ion battery or the like, for example, by being converted into a lithium nickel composite oxide.

The lithium nickel composite oxide can be produced from the precursor according to the present disclosure by, for example, the following method. That is, a method of mixing the nickel composite hydroxide, which is the precursor according to the present disclosure, with a lithium compound serving as a lithium source and firing the obtained mixture.

Examples of the lithium compound include at least one selected from lithium carbonate, lithium nitrate, lithium acetate, lithium hydroxide, lithium oxide, and lithium chloride.

A proportion of the lithium compound and the precursor in the mixture is typically set such that a proportion (mol %) of lithium and each of the other metal species to the total amount of lithium and the metal species contained in the precursor in the positive electrode active material, which is the target substance, is equal to a proportion (mol %) of lithium and each of the other metal species in the mixture. The mixing method is not particularly limited, and a known method can be adopted.

For example, the obtained mixture can be fired at 700° C. to 950° C. for 8 hours to 10 hours to obtain a lithium nickel composite oxide. A known firing furnace such as a muffle furnace can be used for the firing.

It is considered that the positive electrode active material obtained by firing the precursor according to the present disclosure is usually composed of single crystal particles.

Here, the single crystal particle is a single particle that does not constitute a secondary particle, and means a particle consisting of substantially a single crystal. The fact that the particle is a single crystal particle can be confirmed from the fact that a grain boundary cannot be confirmed in the SEM image.

In addition, it is considered that the positive electrode active material obtained by firing the precursor according to the present disclosure usually has a layered rock salt structure.

The precursor of the positive electrode active material provided by the present disclosure can be used as, for example, a precursor of a positive electrode active material constituting a positive electrode of a battery (a lithium ion battery or the like). That is, in the present disclosure, it is possible to provide a battery in which a positive electrode, an electrolyte layer, and a negative electrode are laminated in this order, in which the positive electrode contains a positive electrode active material obtained from the precursor according to the present disclosure.

Hereinafter, the battery will be described.

The positive electrode has a positive electrode layer, and further has a positive electrode collector as necessary.

The positive electrode layer is a layer containing at least a positive electrode active material. The positive electrode active material may contain only the positive electrode active material obtained from the precursor according to the present disclosure, or may further contain other active materials. A content of the positive electrode active material in the positive electrode layer is not particularly limited, and may be, for example, 20% by mass to 80% by mass. The positive electrode layer may contain at least one of an electrolyte, a conductive material, or a binder as necessary.

Examples of the electrolyte include a solid electrolyte. The solid electrolyte may be an inorganic solid electrolyte such as a sulfide solid electrolyte, a halide solid electrolyte, an oxide solid electrolyte, or a complex hydride solid electrolyte, or may be an organic solid electrolyte such as a gel electrolyte. A proportion of the solid electrolyte in the positive electrode layer may be, for example, 10% to 60% by mass.

Examples of the conductive material include a carbon material, metal particles, and a conductive polymer. Examples of the carbon material include a particulate carbon material such as acetylene black (AB) and Ketjen black (KB), and a fibrous carbon material such as vapor-grown carbon fiber (VGCF), carbon nanotube (CNT), and carbon nanofiber (CNF). A proportion of the conductive material in the positive electrode layer may be, for example, 0.1% by mass to 5% by mass.

Examples of the binder include styrene-butadiene rubber (SBR), acrylonitrile-butadiene rubber (NBR), butadiene rubber (BR), polyvinylidene fluoride (PVDF), polytetrafluoroethylene (PTFE), styrene-isoprene-styrene block copolymer (SIS), and ethylene-propylene-diene copolymer (EPDM). A proportion of the binder in the positive electrode layer may be, for example, 0.5% by mass to 5% by mass.

Examples of a material of the positive electrode collector include SUS, Cr, Au, Pt, Zn, aluminum, copper, nickel, iron, titanium, and carbon. A thickness of the positive electrode collector is, for example, 0.1 μm or more and 100 μm or less. A shape of the positive electrode collector may be a foil shape, a plate shape, or the like. A planar shape of the positive electrode collector is not particularly limited, and examples thereof include a circular shape, an elliptical shape, a rectangular shape, and any polygonal shape. The positive electrode collector may have a configuration in which a buffer layer, an elastic layer, or a positive temperature coefficient (PTC) thermistor layer is disposed on a surface thereof.

The negative electrode has a negative electrode layer, and further has a negative electrode collector as necessary.

The negative electrode layer is a layer containing at least a negative electrode active material. In addition, the negative electrode layer may contain at least one of an electrolyte, a conductive material, or a binder as necessary. Examples of the negative electrode active material of the lithium ion battery include a carbon material such as natural graphite, Li single body, and a Li alloy.

Examples of the electrolyte, the conductive material, and the binder used in the negative electrode layer include the same ones as those described in the positive electrode layer. Examples of a material of the negative electrode collector include SUS, aluminum, copper, nickel, iron, titanium, and carbon. A thickness of the negative electrode collector is, for example, 0.1 μm or more and 100 μm or less. A shape of the negative electrode collector may be a foil shape, a plate shape, or the like. A planar shape of the negative electrode collector is not particularly limited, and examples thereof include a circular shape, an elliptical shape, a rectangular shape, and any polygonal shape. The negative electrode collector may have a configuration in which a buffer layer, an elastic layer, or a PTC thermistor layer is disposed on a surface thereof.

The electrolyte layer is a layer provided between the positive electrode layer and the negative electrode layer, and contains at least an electrolyte. Examples of the electrolyte include an electrolytic solution in addition to the solid electrolyte described in the positive electrode layer.

As the electrolytic solution, an aqueous electrolytic solution, a non-aqueous electrolytic solution, or the like can be used. The electrolytic solutions may be used alone or in combination of two or more kinds thereof.

The solvent of the aqueous electrolytic solution contains water as a main component. That is, water may occupy 50 mol % or more, particularly 70 mol % or more, and further 90 mol % or more with respect to the total amount of the solvent (liquid component) constituting the electrolytic solution (100 mol %). On the other hand, an upper limit of the proportion of water in the solvent is not particularly limited. The solvent contains water as a main component, but may contain a solvent other than water. Examples of the solvent other than water include one or more selected from ethers, carbonates, nitriles, alcohols, ketones, amines, amides, sulfur compounds, and hydrocarbons. The solvent other than water may be 50 mol % or less, particularly 30 mol % or less, and further 10 mol % or less with respect to the total amount of the solvent (liquid component) constituting the electrolytic solution (100 mol %).

The aqueous electrolytic solution contains an electrolyte. As the electrolyte for the aqueous electrolytic solution, a known electrolyte in the related art can be used. Examples of the electrolyte include a lithium salt of an imide acid compound, a nitrate, an acetate, and a sulfate. Specific examples of the electrolyte include lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(nonafluorobutanesulfonyl)imide, lithium nonafluoro-N-[(trifluoromethane)sulfonyl] butanesulfonylamide, lithium N,N-hexafluoro-1,3-disulfonylimide, CH₃COOLi, LiPF₆, LiBF₄, Li₂SO₄, and LiNO₃.

A concentration of the electrolyte in the aqueous electrolytic solution can be appropriately set according to the characteristics of the battery to be obtained within a range not exceeding the saturation concentration of the electrolyte with respect to the solvent. The reason is that, in a case where a solid electrolyte remains in the aqueous electrolytic solution, the solid may hinder the battery reaction.

For example, in a case where LiTFSI is used as the electrolyte, the aqueous electrolytic solution may contain 1 mol or more, particularly 5 mol or more, and further 7.5 mol or more of LiTFSI per 1 kg of water. The upper limit thereof is not particularly limited, and may be, for example, 25 mol or less.

As the non-aqueous electrolytic solution, a solution containing a lithium salt and a non-aqueous solvent is usually used.

Examples of the lithium salt include inorganic lithium salts such as LiPF₆, LiBF₄, LiClO₄, and LiAsF₆; and organic lithium salts such as LiCF₃SO₃, LiN(SO₂CF₃)₂ (Li-TFSI), LiN(SO₂C₂F₅)₂, and LiC(SO₂CF₃)₃.

Examples of the non-aqueous solvent include ethylene carbonate (EC), propylene carbonate (PC), butylene carbonate (BC), dimethyl carbonate (DMC), diethyl carbonate (DEC), ethyl methyl carbonate (EMC), γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethyl sulfoxide (DMSO), and mixtures thereof. From the viewpoint of ensuring a high dielectric constant and a low viscosity, a mixture of a cyclic carbonate compound having a high dielectric constant and a high viscosity, such as EC, PC, and BC, and a chain-like carbonate compound having a low dielectric constant and a low viscosity, such as DMC, DEC, and EMC, may be used, or a mixture of EC and DEC may be used.

A concentration of the lithium salt in the non-aqueous electrolytic solution may be, for example, 0.3 M to 5 M.

The non-aqueous electrolytic solution may contain an ionic liquid. The ionic liquid may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives thereof.

As the electrolyte layer, a separator which is impregnated with the electrolytic solution and prevents the contact between the positive electrode layer and the negative electrode layer may be used.

The material of the separator is not particularly limited as long as it is a porous film, and examples thereof include resins such as polyethylene (PE), polypropylene (PP), polyester, polyvinyl alcohol, cellulose, and polyamide, among which polyethylene or polypropylene may be used. In addition, the separator may have a single layer structure or a multi-layer structure. Examples of the separator having a multi-layer structure include a separator having a two-layer structure of PE/PP, and a separator having a three-layer structure of PP/PE/PP or PE/PP/PE.

The separator may be a nonwoven fabric such as a resin nonwoven fabric or a glass fiber nonwoven fabric.

The battery may further have a constraint tool that applies a constraint pressure to the positive electrode layer, the electrolyte layer, and the negative electrode layer in the thickness direction. The constraint pressure may be, for example, 0.1 MPa to 100 MPa.

The type of the battery is not particularly limited, and is usually a battery in which a metal ion is conducted between the positive electrode layer and the negative electrode layer. Examples of such a battery include a lithium ion battery. In addition, the battery may be a primary battery or a secondary battery, and may be a secondary battery among these. It is because a secondary battery can be repeatedly charged and discharged and is useful, for example, as an in-vehicle battery.

The shape of the battery is not particularly limited, and may be, for example, a coin type, a cylindrical type, a square type, a sheet type, a button type, a flat type, or a laminated type.

Examples of the application of the battery include a power source of a vehicle such as a hybrid electric vehicle (HEV), a plug-in hybrid electric vehicle (PHEV), a battery electric vehicle (BEV), a gasoline vehicle, and a diesel vehicle. In particular, the battery may be used as a power source for driving a hybrid electric vehicle (HEV), a plug-in hybrid electric vehicle (PHEV), or a battery electric vehicle (BEV). The battery may be used as a power source of a moving body other than a vehicle (for example, a train, a ship, or an airplane), or may be used as a power source of an electrical product, such as an information processing device.

### Preparation of Precursor of Positive Electrode Active Material

### Synthesis of Precursor Particles a to F

NiSO₄, CoSO₄, and MnSO₄ were dissolved in ion exchange water to prepare a metal raw material aqueous solution. The Ni/Co/Mn ratio in the metal raw material aqueous solution was set to 80/10/10 in mol %. The concentration of the metal raw material aqueous solution (proportion of all raw materials to the metal raw material aqueous solution) was set to 1.5 mol %.

An NH₃ aqueous solution was added to the reaction container in a constant amount, and the inside of the reaction container was replaced with nitrogen while stirring with a stirrer. A NaOH aqueous solution was added to the reaction container, and the metal raw material aqueous solution and the NH₃ aqueous solution were added dropwise while maintaining the pH at an alkaline level (pH=12). During the dropwise addition, the stirring speed of the stirrer was set to 400 rpm, the reaction temperature was set to 60° C., and the precursor particles A to E were synthesized. The reaction time of the precursor particles A to E was set such that the precursor particles B and C were longer and the precursor particles D and E were shorter with the precursor particle A as a reference. In addition, during the dropwise addition, the stirring speed of the stirrer was set to 800 rpm, the reaction temperature was set to 60° C., the reaction time was set to 10 hours, and the precursor particle F was synthesized. After the reaction is completed, a drying treatment is performed at 120° C. for 1 hour in an inert gas atmosphere.

SEM observation was performed on each of the obtained precursor particles A to F, and the true roundness was calculated by the method. The true roundness, Dmin, and Dmax are shown in Table 1.

TABLE 1

| | True roundness | Dmin | Dmax |
|---|---|---|---|
| Unit | — | [μm] | [μm] |
| Precursor particle A | 0.30 | 4.7 | 5.3 |
| Precursor particle B | 0.25 | 6.7 | 7.2 |
| Precursor particle C | 0.20 | 9.4 | 9.8 |
| Precursor particle D | 0.40 | 1.3 | 2.1 |
| Precursor particle E | 3.60 | 3.0 | 10.2 |
| Precursor particle F | 0.10 | 4.8 | 5.0 |

In Table 1, in a case where the precursor particle F (stirring speed: 800 rpm) was compared with the precursor particles A to E (stirring speed: 400 rpm), it was found that the high true roundness precursor particles having a true roundness of 0.20 or more (more than 0.10) could be synthesized by reducing the stirring speed. In addition, in a case where the precursor particles A to E having the same stirring speed were compared, it was found that the true roundness of the precursor particles was reduced (precursor particles B and C) by increasing the reaction time with the precursor particle A as a reference, and the true roundness of the precursor particles was increased (precursor particles D and E) by reducing the reaction time.

### Preparation of precursor of Example 1

The high true roundness precursor particles A having a true roundness of 0.30 and the low true roundness precursor particles F having a true roundness of 0.10 were mixed at a ratio of 10% by mass and 90% by mass, respectively, to obtain a precursor of Example 1.

### Preparation of Precursor of Example 2

The high true roundness precursor particles A having a true roundness of 0.30 and the low true roundness precursor particles F having a true roundness of 0.10 were mixed at a ratio of 20% by mass and 80% by mass, respectively, to obtain a precursor of Example 2.

### Preparation of Precursor of Example 3

The high true roundness precursor particles A having a true roundness of 0.30 and the low true roundness precursor particles F having a true roundness of 0.10 were mixed at a ratio of 50% by mass and 50% by mass, respectively, to obtain a precursor of Example 3.

### Preparation of Precursor of Example 4

The high true roundness precursor particles A having a true roundness of 0.30 were used at 100% by mass to obtain a precursor of Example 4.

### Preparation of Precursor of Example 5

The high true roundness precursor particles B having a true roundness of 0.25 and the low true roundness precursor particles F having a true roundness of 0.10 were mixed at a ratio of 50% by mass and 50% by mass, respectively, to obtain a precursor of Example 5.

### Preparation of Precursor of Example 6

The high true roundness precursor particles C having a true roundness of 0.20 were used at 100% by mass to obtain a precursor of Example 6.

### Preparation of Precursor of Example 7

The high true roundness precursor particles D having a true roundness of 0.40 and the low true roundness precursor particles F having a true roundness of 0.10 were mixed at a ratio of 50% by mass and 50% by mass, respectively, to obtain a precursor of Example 7.

### Preparation of Precursor of Example 8

The high true roundness precursor particles E having a true roundness of 3.60 and the low true roundness precursor particles F having a true roundness of 0.10 were mixed at a ratio of 50% by mass and 50% by mass, respectively, to obtain a precursor of Example 8.

### Preparation of Precursor of Comparative Example 1

The low true roundness precursor particles F having a true roundness of 0.10 were used at 100% by mass to obtain a precursor of Comparative Example 1.

### Synthesis of Positive Electrode Active Material

The precursor of each of Examples 1 to 8 and Comparative Example 1 and a lithium compound (LiOH) as a lithium source were mixed in a mortar. The obtained mixture was fired at 950° C. for 10 hours in a firing furnace to synthesize positive electrode active materials (LiNi_{0.8}Co_{0.1}Mn_{0.1}O₂) of Examples 1 to 8 and Comparative Example 1.

### Production of Positive Electrode

Positive electrodes of Examples 1 to 8 and Comparative Example 1 were produced using each of the positive electrode active materials of Examples 1 to 8 and Comparative Example 1.

Specifically, first, a positive electrode composite paste containing each positive electrode active material, acetylene black as a conductive material, and PVDF (4% by mass) as a binder was applied onto a surface of a metal foil (Al foil) as a positive electrode collector using a film applicator with a film thickness adjustment function (manufactured by Allgrid Co., Ltd.). Thereafter, the positive electrode mixture paste was dried at 80° C. for 5 minutes in a dryer to produce positive electrodes of Examples 1 to 8 and Comparative Example 1, each having a positive electrode layer on the positive electrode collector.

### Measurement of Peel Strength

First, a polyethylene tape having a width of 2 cm and a length of 20 cm was attached to the positive electrode layer side of the produced positive electrode, and air bubbles were removed to adhere the polyethylene tape. Next, the positive electrode with the polyethylene tape was cut into a size of 1 cm in width×15 cm in length using a dumbbell cutter to produce a sample for a peeling test.

In the sample for a peeling test, the polyethylene tape and the positive electrode layer were peeled off from the collector surface, and the peeling force (load, N/m) at that time was measured. The peeling conditions were set to a peeling angle of 90°+5°, a peeling rate of 20 mm/min, and a peeling length of 60 mm. In the obtained peeling force data, a frequency distribution was taken at an interval of 0.05 N/m, and the most frequent value was defined as the peel strength (peel strength between the positive electrode collector and the positive electrode layer).

The peel strength of Examples 1 to 8 was standardized with the peel strength of Comparative Example 1 as a reference, according to the following expression.

$$Standardized peel strength = ( Peel strength of each of Examples ) / ( Peel strength of Comparative Example 1 )$$

The results are shown in Table 2. Table 2 also shows the proportion of the high true roundness precursor particles (precursor particles A to E) in the precursor of each of Examples, the true roundness, Dmin, and Dmax. It is noted that, in Table 2, for Comparative Example 1 (containing 100% by mass of precursor particles F) not containing the high true roundness precursor particles, the true roundness, Dmin, and Dmax of the precursor particles F are shown.

TABLE 2

| | Proportion of | True roundness | | | |
|---|---|---|---|---|---|
| | high true | of high true | Dmin of high | Dmax of high | |
| | roundness | roundness | true roundness | true roundness | Standardized |
| | precursor | precursor | precursor | precursor | peel |
| | particle | particle | particle | particle | strength |
| Unit | [%] | — | [μm] | [μm] | — |
| Example 1 | 10 | 0.30 | 4.7 | 5.3 | 1.04 |
| Example 2 | 20 | 0.30 | 4.7 | 5.3 | 1.08 |
| Example 3 | 50 | 0.30 | 4.7 | 5.3 | 1.20 |
| Example 4 | 100 | 0.30 | 4.7 | 5.3 | 1.30 |
| Example 5 | 50 | 0.25 | 6.7 | 7.2 | 1.15 |
| Example 6 | 100 | 0.20 | 9.4 | 9.8 | 1.12 |
| Example 7 | 50 | 0.40 | 1.3 | 2.1 | 1.21 |
| Example 8 | 50 | 3.60 | 3.0 | 10.2 | 1.10 |
| Comparative | 0 | [0.10] | [4.8] | [5.0] | 1.00 |
| Example 1 | | | | | |

As shown in Table 2, the positive electrodes of Examples 1 to 8 exhibited a high peel strength as compared with Comparative Example 1. It is considered that the reason is that the positive electrode active material obtained from the precursor containing the high true roundness precursor particles (precursor particles A to E having a true roundness of more than 0.10) improved the anchoring effect of the positive electrode layer on the positive electrode collector.

From the comparison of Examples 1 to 4 containing the precursor particles A having a true roundness of 0.30 at different ratios, it is considered that the higher the proportion of the high true roundness precursor particles, the higher the peel strength.

In addition, from the comparison of Examples 3, 5, 7, and 8 containing the high true roundness precursor particles at a ratio of 50% by mass, and the comparison of Examples 4 and 6 containing the high true roundness precursor particles at 100% by mass, it can be seen that, in a range of the true roundness of 0.25 to 0.40, the higher the true roundness of the precursor particles, the higher the peel strength.

What is claimed is:

1. A precursor of a positive electrode active material, wherein:
the precursor is a nickel composite hydroxide; and
the precursor contains more than 0% by mass of precursor particles having a true roundness of more than 0.10, the true roundness being calculated from a scanning electron microscope (SEM) image.

2. The precursor according to claim 1, wherein the true roundness is 0.20 or more, and a particle diameter on a long side of the precursor particles is 2.1 μm or more and 10.2 μm or less.

3. The precursor according to claim 1, wherein the true roundness is 0.20 or more, and the precursor contains 10% by mass or more of the precursor particles.

4. The precursor according to claim 1, wherein the true roundness is 3.60 or less.

5. The precursor according to claim 1, wherein the nickel composite hydroxide is a nickel cobalt manganese composite hydroxide.
